(19) United States
(12) Patent Application Publication
(10) Pub. No.: US 2011/0125791 A1
(43) Pub. Date: May 26, 2011

(54) QUERY CLASSIFICATION USING SEARCH RESULT TAG RATIOS

(75) Inventors: Arnd Christian Konig, Kirkland, WA (US); Venkatesh Ganti, Redmond, WA (US); Xiao Li, Bellevue, WA (US)

(73) Assignee: Microsoft Corporation, Redmond, WA (US)

(21) Appl. No.: 12/625,594

(22) Filed: Nov. 25, 2009

(51) Int. Cl. G06F 17/30

(52) U.S. Cl. 707/770; 707/772; 707/774; 707/E17.008; 707/E17.014; 707/E17.032

(57) ABSTRACT

Techniques are described herein for classifying a search query with respect to query intent using search result tag ratios. A tag is a character or a combination of characters (e.g., one or more words) that indicates a property of a document, such as a topic of the document, a type of entity (i.e., subject matter) the document references, etc. A search result tag ratio is defined as a fraction (e.g., a proportion, a percentage, etc.) of the documents in a search result that includes a respective tag. A search query may be classified based on back-off ratios, which are tag ratios of search queries that are related to the search query to be classified. Tag ratios may be pre-computed (i.e., calculated before the corresponding search queries are received from users).

### BACKGROUND

A search engine is a type of program that may be hosted and executed by a server. A server may execute a search engine to enable users to search for documents in a networked computer system based on search queries that are provided by the users. For instance, the server may match search terms (e.g., keywords) that are included in a user's search query to metadata associated with documents that are stored in (or otherwise accessible to) the networked computer system. Documents that are retrieved in response to the search query are provided to the user as a search result. The documents are often ranked based on how closely their metadata matches the search terms. For example, the documents may be listed in the search result in an order that corresponds to the rankings of the respective documents. The document having the highest ranking is usually listed first in the search result. In some instances, contextual advertisements are provided in conjunction with the search result based on the search terms.

It may be desirable to classify a search query in order to provide a more relevant search result and/or more relevant contextual advertisements to a user who provides a search query. Factors that are used to classify a search query are referred to as features. A collection of such features is referred to as a feature space.

For instance, a variety of techniques has been proposed for classifying search queries with respect to query intent. However, each such technique has its limitations. In one example, word-occurrence classification techniques have been developed that classify search queries based on the occurrence of designated search terms in the search queries. However, search queries often include relatively few search terms. For instance, an average Web search query includes fewer than three search terms. Moreover, the vocabulary used in search queries is relatively vast. Thus, word-occurrence classification techniques are often characterized by a relatively large and sparse feature space. In another example, search-based classification techniques have been developed that classify search queries based on features that are extracted from search results that are provided in response to a search query. However, conventional search-based classification techniques are often characterized by substantial latency, which may render such techniques unacceptable in practice.

### SUMMARY

Various approaches are described herein for, among other things, classifying a search query with respect to query intent using search result tag ratios. A tag is a character or a combination of characters (e.g., one or more words) that indicates a property of a document, such as a topic of the document, a type of entity (i.e., subject matter) the document references, etc. A search result tag ratio is a fraction (e.g., a proportion, a percentage, etc.) of the documents in a search result that includes a particular tag. For instance, a search result may include a set of documents. A number of the documents in the set that include a particular tag may be divided by the total number of documents in the set to determine a tag ratio for the tag and the search result.

One type of tag ratio upon which a search query may be classified is a back-off ratio. A back-off ratio is a tag ratio of a search query that is related to a search query to be classified. Search queries that are related to a search query to be classified are referred to as “related search queries” with respect to the search query to be classified. For instance, the related search queries may be acronyms, synonyms, sub-queries, etc. of the search query to be classified.

Tag ratios for designated search queries may be pre-computed, meaning that those tag ratios may be computed before the designated search queries are received from users. For example, the tag ratios may be calculated, stored, and indexed by the corresponding search queries in a data structure (e.g., a look-up table) in memory. The tag ratios may be retrieved from the data structure when a search query to which the tag ratios pertain is to be classified.

An example method is described in which a search query that includes one or more search terms is executed against a corpus of documents to determine a search result that includes a subset of the documents. Each document includes one or more respective tags. A fraction of the subset of the documents that includes the search term(s) and a predetermined tag that is related to the search query is determined to provide a tag ratio regarding the search query. The search query is classified with respect to query intent at a server based on the tag ratio.

Another example method is described in which a first search query that is related to a second search query and that includes one or more search terms is executed against a corpus of documents to determine a search result that includes a subset of the documents. Each document includes one or more respective tags. A fraction of the subset of the documents that includes the search term(s) and a predetermined tag that is related to the first search query is determined to provide a back-off ratio regarding the second search query. The second search query is classified with respect to query intent at a server based on the back-off ratio.

An example system is described that includes a query execution module, a feature module, and a classification module. The query execution module is configured to execute a search query that includes one or more search terms against a corpus of documents to determine a search result that includes a subset of the documents. Each document includes one or more respective tags. The feature module is configured to determine a fraction of the subset of the documents that includes the search term(s) and a predetermined tag that is related to the search query to provide a tag ratio regarding the search query. The classification module is configured to classify the search query with respect to query intent based on the tag ratio.

Another example system is described that includes a query execution module, a feature module, and a classification module. The query execution module is configured to execute a first search query that is related to a second search query, and that includes one or more search terms, against a corpus of documents to determine a search result that includes a subset of the documents. Each document includes one or more respective tags. The feature module is configured to determine a fraction of the subset of the documents that includes the search term(s) and a predetermined tag that is related to the first search query to provide a back-off ratio regarding the second search query. The classification module is configured to classify the second search query with respect to query intent based on the back-off ratio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer system in accordance with an embodiment.

FIG. 2 depicts a flowchart of a method for classifying a search query with respect to query intent using search result tag ratios in accordance with an embodiment.

FIGS. 3, 6, 8, 12, and 15 are block diagrams of example implementations of a server shown in FIG. 1 in accordance with embodiments.

FIGS. 4, 5, and 7 depict flowcharts that show example ways to implement the method of FIG. 2 in accordance with embodiments.

FIG. 9 depicts a flowchart of another method for classifying a search query with respect to query intent using search result tag ratios in accordance with an embodiment.

FIGS. 10, 11, 13, and 14 depict flowcharts that show example ways to implement the method of FIG. 9 in accordance with embodiments.

FIG. 16 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments for Query Classification Using Search Result Tag Ratios

This section begins with an overview of some concepts regarding classification of search queries with respect to query intent using search result tag ratios. An environment in which example structural and operational embodiments may be implemented is then discussed, followed by a more detailed discussion of the example structural and operational embodiments.

Understanding the intent that underlies a user's search query can increase the likelihood that relevant documents and/or relevant contextual advertisements are provided to the user in response to execution of the search query. Receiving more relevant documents and/or contextual advertisements is likely to improve the user's satisfaction with regard to the search experience. Example embodiments classify search queries with respect to query intent using search result tag ratios. A tag is a character or a combination of characters (e.g., one or more words) that indicates a property of a document, such as a topic of the document, a type of entity (i.e., subject matter) the document references, etc. A search result tag ratio is defined as a fraction (e.g., a proportion, a percentage, etc.) of the documents in a search result that includes a respective tag. For instance, if a search result includes one-hundred documents, and thirty-five of those documents include a tag, the tag ratio for that tag and the corresponding search query is 35/100=35%.

One type of tag ratio upon which a search query may be classified is a back-off ratio. A back-off ratio is a tag ratio of a search query that is related to a search query to be classified. Search queries that are related to a search query to be classified are referred to as “related search queries” with respect to the search query to be classified. For instance, the related search queries may be acronyms, synonyms, sub-queries, etc., of the search query to be classified. The tag ratio of the search query to be classified may or may not be taken into account when classifying the search query based on back-off ratios.

In accordance with some example embodiments, tag ratios for designated search queries are pre-computed, meaning that those tag ratios are computed before the designated search queries are received from users. For example, the tag ratios may be calculated, stored, and indexed by the corresponding search queries in a data structure (e.g., a look-up table) in memory. The tag ratios may be retrieved from the data structure when a search query to which the tag ratios pertain is to be classified.

Some concepts regarding classification of search queries with respect to query intent using search result tag ratios are described as follows for purposes of illustration. Throughout this document, a search query may be represented by the variable q, and the number of words in the query q may be denoted as |q|. The corpus of documents against which the query q is executed is denoted as D={d1, . . . , dj}. The set of all distinct words in the corpus D (a.k.a. the power-set of D) is represented by the variable ν. The power-set of D may be denoted as 2̂ν. The number of documents in the corpus D that includes a keyword υ∈ ν is denoted as freq(υ):=|{d ∈ D|υ∈ d}|. Similarly, the notation freq(q) represents the number of documents in the corpus D that contain a set of keywords q ⊂ ν. The set of all tags that may be included in documents in the corpus D is denoted as T={t1, . . . , tp}. A document d that includes a tag t is represented using the shorthand notation t ∈ d, and the set of all documents that include the tag t is denoted as D̂t ⊂ D.

The result of a keyword-search for a query q is represented as result(q) ⊂ D, which is defined as the set of all documents retrieved as a response to a query q . Any of a variety of search semantics may be incorporated into the example notations provided herein depending on the query and the corpus. For example, containment-semantics may be used to model a query as a set of keywords q={w1, . . . , wk} and resultD(q)={d ∈ D|d contains all ωi ∈ q}. In accordance with these example containment-semantics, a query q is represented as an unordered set of words.

Given a set of documents Δ ⊂ D and a tag t ∈ T, the tag ratio of the corpus Δ with respect to the tag t is denoted as ratioΔ(t)=|{d ∈ Δ|d is tagged with t}|/|Δ|, where |Δ| represents the number of documents in the set of documents Δ. If Δ corresponds to the result of a query q, the notation ratio(q, t):=ratio _{result(q)}(t) is used. An empty query result is denoted as ratio₀(t)=0.

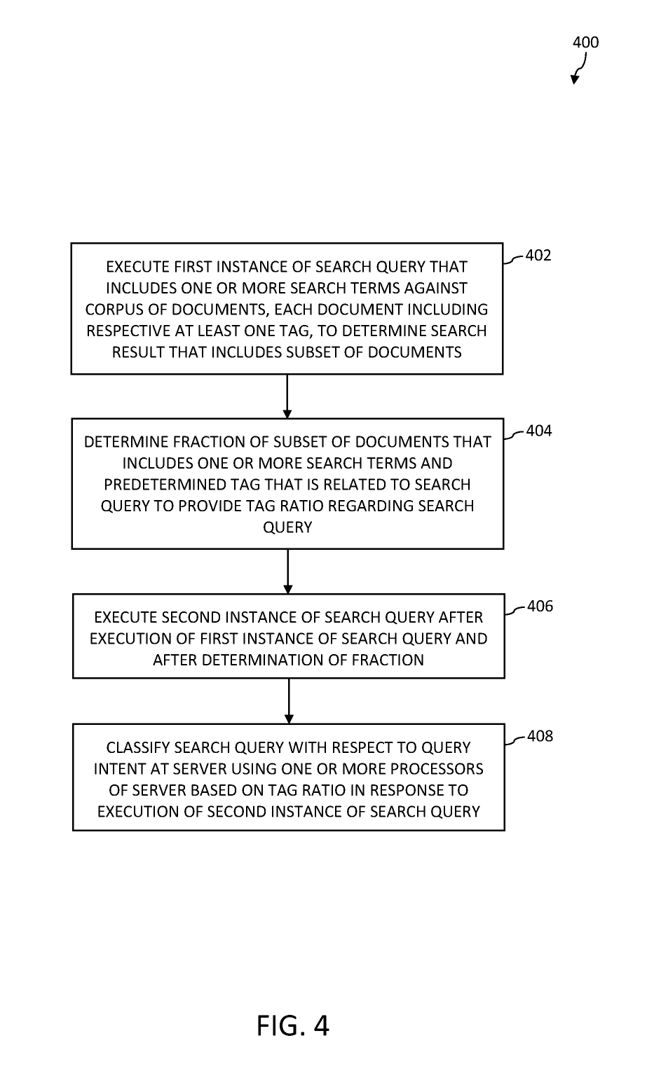

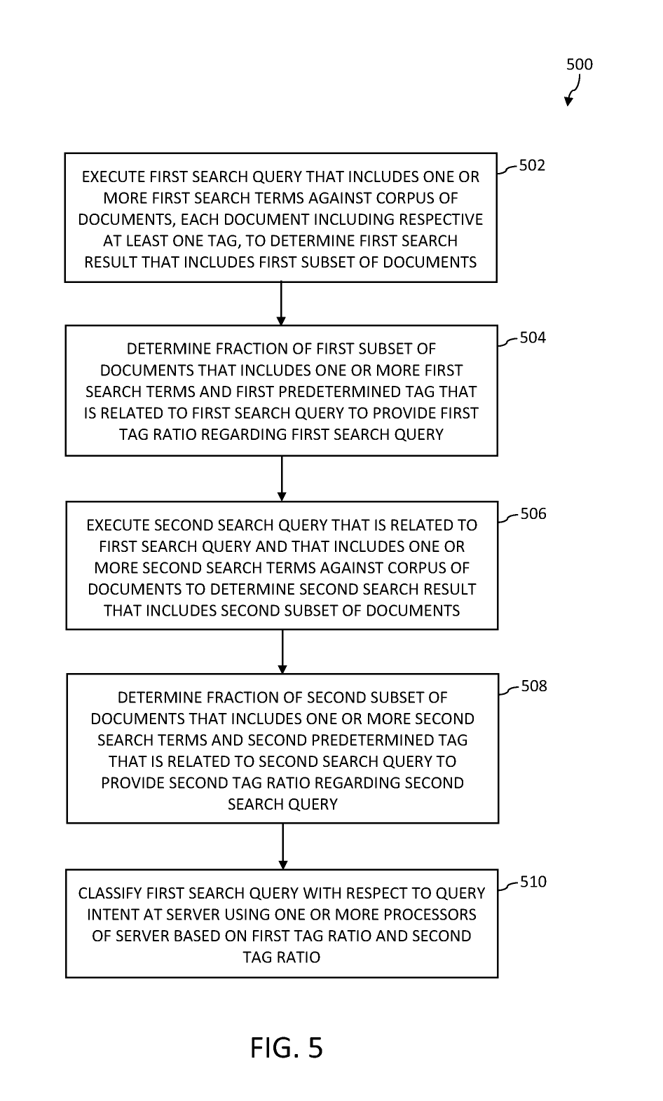

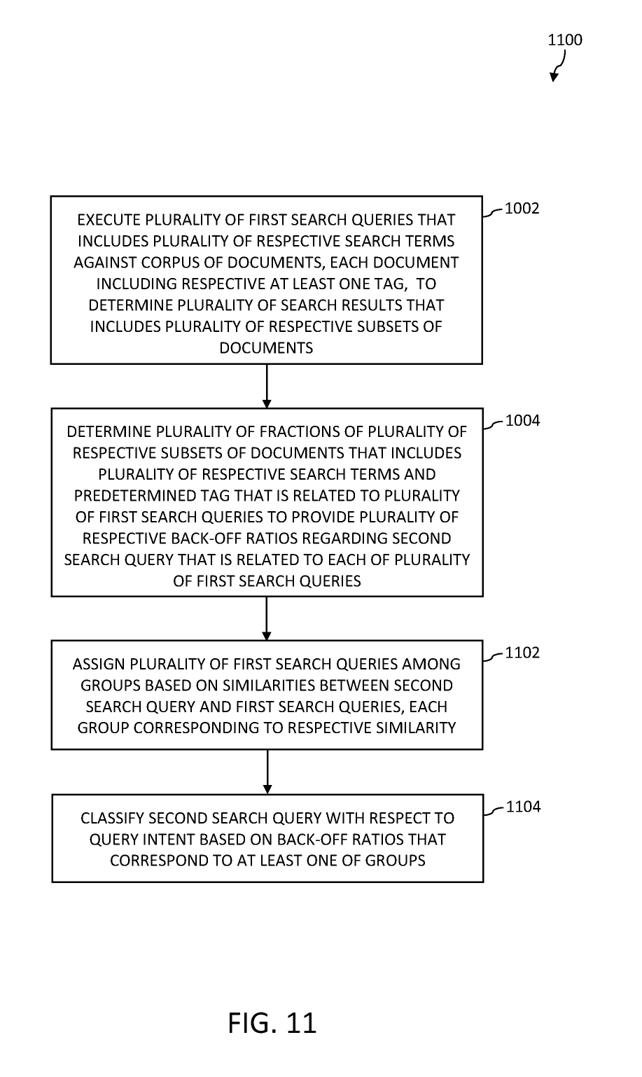

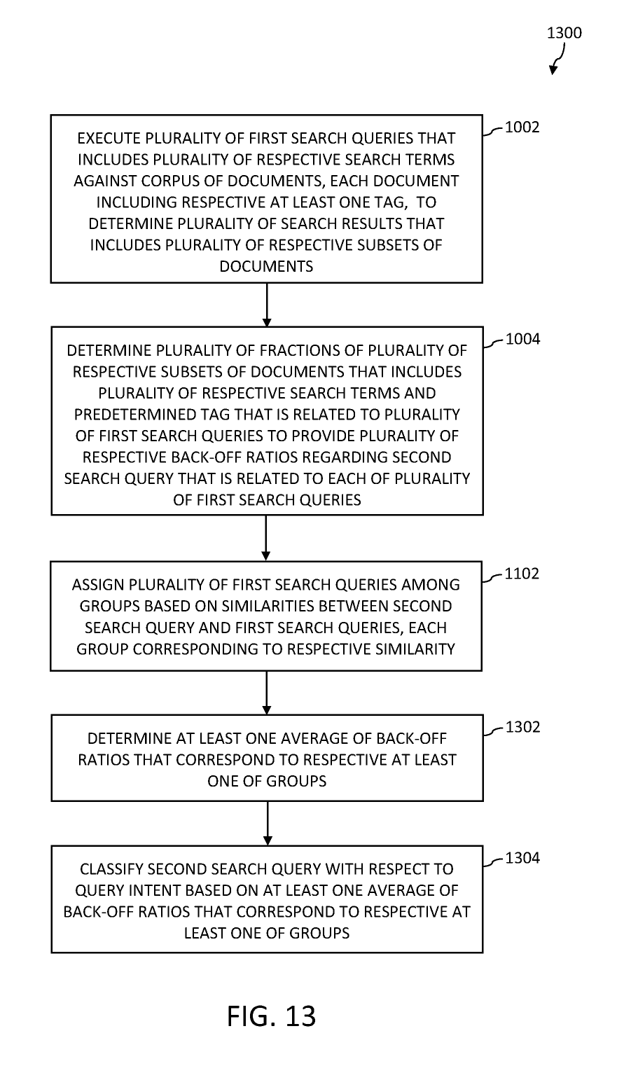

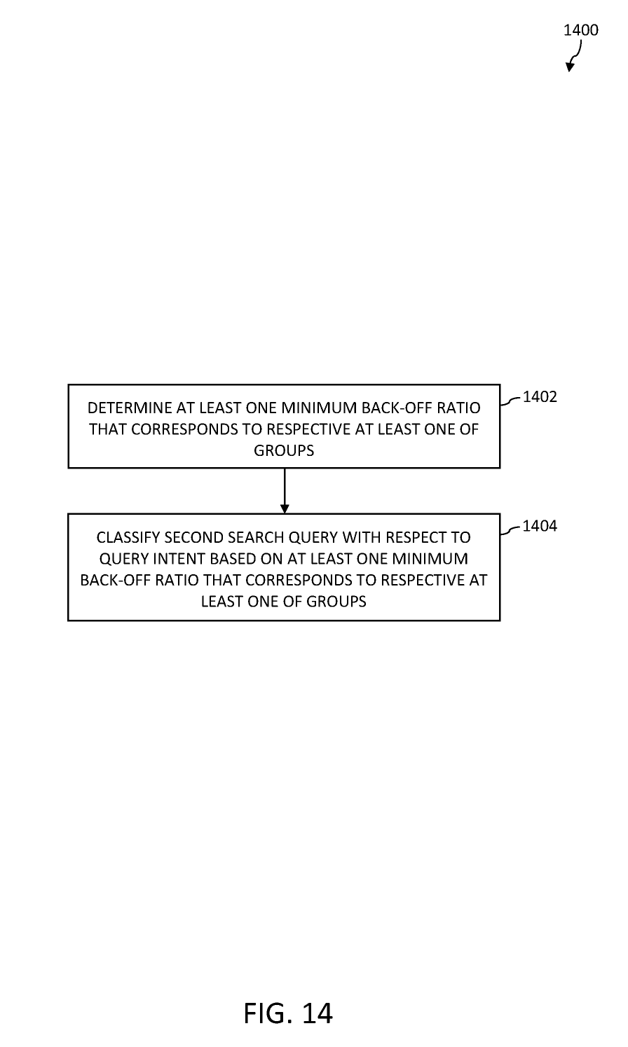

The example notations described above are provided as a foundation upon which notations regarding other concepts may expand in the following discussion. For instance, additional notations are provided below with reference to FIG. 4 regarding search queries that are related to the search query to be classified (a.k.a. “related” search queries), FIG. 5 regarding sub-queries, FIG. 11 regarding grouping of queries, and FIGS. 13 and 14 regarding properties of tag ratios. The example notations described herein are provided for illustrative purposes and are not intended to be limiting. Other suitable notations may be used to describe the corresponding concepts.

Techniques that classify search queries with respect to query intent using search result tag ratios have a variety of benefits as compared to conventional query classification techniques. For example, the classification features that are used in these techniques (referred to herein as “tag ratio features”) may be derived from a variety of corpora. Classifying search queries using tag ratio features may result in substantial increases in accuracy for various query classification tasks (i.e., classifications with respect to various types of query intent). Tag ratio features may be pre-computed (i.e., calculated before the corresponding search queries are received from users). For instance, using pre-computed tag ratio features may reduce latency regarding classification of search queries when the queries are received from users, as compared to conventional search-based classification techniques that use search engine features (i.e., features in retrieved documents). The number of tags that are used to classify search queries may be fewer than the total number of search terms in the search queries, which may reduce the size and/or sparseness of the feature space. Tag ratio features may generalize better across search queries and reduce the amount of training data that is needed to train the features, as compared to word-occurrence classification features, which are based on the occurrence of designated search terms in search queries. A subset of the total number of query-tag combinations may be used to reduce memory requirements regarding classification of search queries without substantially reducing classification accuracy.

The classification techniques described herein may use features that are not based on search result tag ratios in addition to tag ratio features. For instance, each feature may provide a numerical value for purposes of classifying a search query. The numerical values of the respective features may be combined using a suitable technique, such as linear interpolation, polynomial interpolation, etc. to provide a combined value. The combined value may be used to classify the search query.

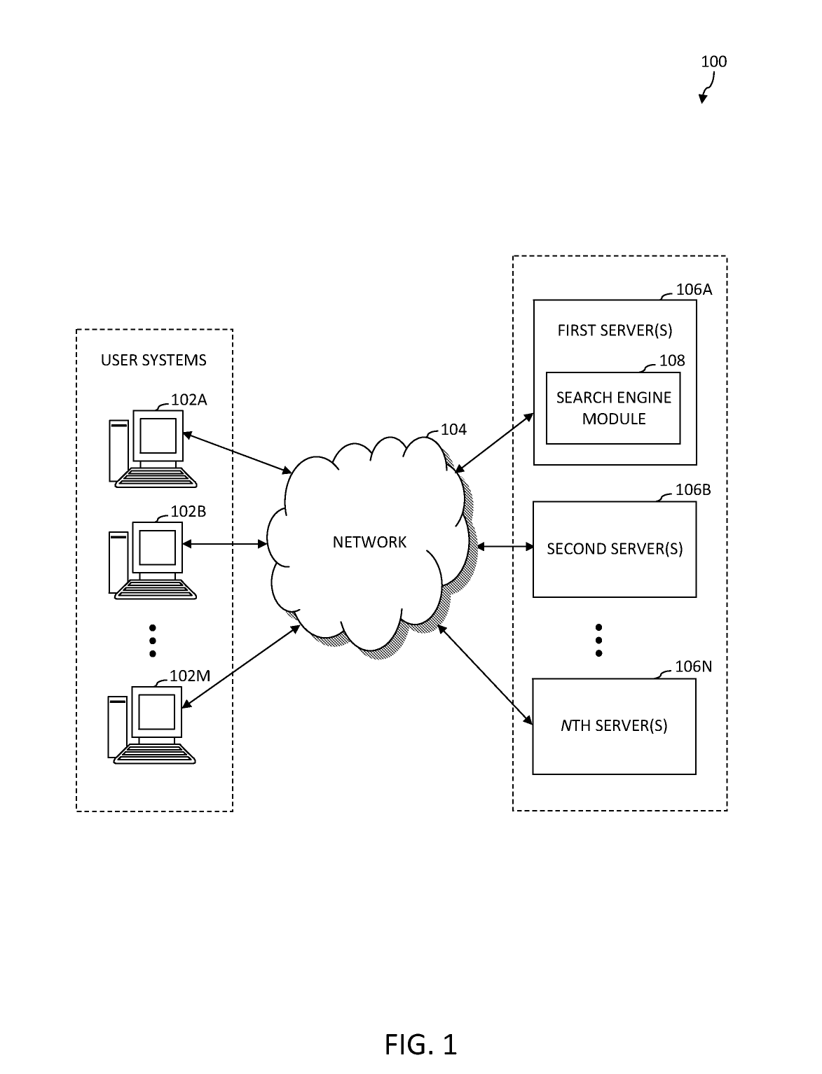

FIG. 1 is a block diagram of an example computer system 100 in accordance with an embodiment. Generally speaking, computer system 100 operates to provide information to users in response to requests (e.g., hypertext transfer protocol (HTTP) requests) that are received from the users. The information may include documents (e.g., Web pages, images, video files, etc.), output of executables, and/or any other suitable type of information. For instance, user system 100 may provide search results in response to search queries that are provided by users. According to example embodiments, computer system 100 operates to classify search queries with respect to query intent using search result tag ratios. Further detail regarding techniques for classifying search queries with respect to query intent using search result tag ratios is provided in the following discussion.

As shown in FIG. 1, computer system 100 includes a plurality of user systems 102A-102M, a network 104, and a plurality of servers 106A-106N. Communication among user systems 102A-102M and servers 106A-106N is carried out over network 104 using well-known network communication protocols. Network 104 may be a wide-area network (e.g., the Internet), a local area network (LAN), another type of network, or a combination thereof

User systems 102A-102M are processing systems that are capable of communicating with servers 106A-106N. An example of a processing system is a system that includes at least one processor that is capable of manipulating data in accordance with a set of instructions. For instance, a processing system may be a computer, a personal digital assistant, etc. User systems 102A-102M are configured to provide requests to servers 106A-106N for requesting information stored on (or otherwise accessible via) servers 106A-106N. For instance, a user may initiate a request for information using a client (e.g., a Web browser, Web crawler, or other type of client) deployed on a user system 102 that is owned by or otherwise accessible to the user. In accordance with some example embodiments, user systems 102A-102M are capable of accessing Web sites hosted by servers 104A-104N, so that user systems 102A-102M may access information that is available via the Web sites. Such Web sites include Web pages, which may be provided as hypertext markup language (HTML) documents and objects (e.g., files) that are linked therein, for example.

It will be recognized that any one or more user systems 102A-102M may communicate with any one or more servers 106A-106N. Although user systems 102A-102M are depicted as desktop computers in FIG. 1, persons skilled in the relevant art(s) will appreciate that user systems 102A-102M may include any client-enabled system or device, including but not limited to a laptop computer, a personal digital assistant, a cellular telephone, or the like.

Servers 106A-106N are processing systems that are capable of communicating with user systems 102A-102M. Servers 106A-106N are configured to execute software programs that provide information to users in response to receiving requests from the users. For example, the information may include documents (e.g., Web pages, images, video files, etc.), output of executables, or any other suitable type of information. In accordance with some example embodiments, servers 106A-106N are configured to host respective Web sites, so that the Web sites are accessible to users of computer system 100.

One type of software program that may be executed by any one or more of servers 106A-106N is a search engine. A search engine is executed by a server to search for information in a networked computer system based on search queries that are provided by users. First server(s) 106A is shown to include search engine module 108 for illustrative purposes. Search engine module 108 is configured to execute a search engine. For instance, search engine module 108 may search among servers 106A-106N for requested information. Upon determining instances of information that are relevant to a user's search query, search engine module 108 provides the instances of the information as a search result to the user. Search engine module 108 may rank the instances based on their relevance to the search query. For instance, search engine module 108 may list the instances in the search result in an order that is based on the respective rankings of the instances.

In accordance with example embodiments, search engine module 108 is configured to classify search queries using search result tag ratios. For instance, each of the documents that is stored in (or otherwise accessible to) computer system 100 can include respective tag(s). When search engine module 108 retrieves a search result in response to receiving a search query, search engine module 108 determines how many of the documents in the search result include each of the tag(s). For instance, search engine module 108 may determine that a first number of the documents include a first tag, a second number of the documents include a second tag, and so on. Search engine module 108 divides the first number by the total number of documents in the search result to provide a first search result tag ratio. Search engine module 108 divides the second number by the total number of documents in the search result to provide a second search result tag ratio, and so on. Search engine module 108 uses these tag ratios to classify the search query with respect to query intent. For instance, properties that are derived from the tag ratios may be used to classify the search query. Some example properties and techniques for classifying a search query based on those properties are discussed below with reference to FIGS. 13-15.

The example query classification techniques described herein are applicable to any of a variety of classification tasks. A classification task is a classification operation that is performed with respect to a designated type of query intent. Some example types of query intent include, but are not limited to, product intent, entertainment intent, retail intent, etc. Some approaches for classifying search queries with respect to these example types of query intent will now be discussed.

Product intent means that a search query refers to a specific product or a class of products and is intended to research, purchase, or review the product(s). For instance, categories of named entities (e.g., commercial products) that are included in documents of a search result may indicate the intent of a search query in response to which the search result is provided. For example, queries that have product intent for a designated category (e.g., consumer electronics) may result in documents that include related product entities (e.g., DVDs, music). The occurrence of one or more entities from a designated category in a document may constitute a tag. For example, each tag in the set of all tags T may correspond to a different product category. In accordance with this example, a document is deemed to be “tagged” if it includes an entity in a corresponding category. The relative frequencies with which the respective tags occur in a search result may be used as features for classifying the corresponding search query. For example, documents that mention a substantial number of different lenses may indicate that the corresponding search query has photography intent.

Next, consider the task of identifying queries with entertainment intent for which search engine module 108 may be configured to display additional picture galleries or videos, for example. One approach is to use a specific corpus (e.g., Wikipedia®) for which a rich set of document categories is available. The document categories (e.g. Wikipedia® categories such as American Actor, Film by Genre: Romance, Dance, etc.) are used as the tags. The relative frequencies with which these tags occur in the search result may be used as classification features.

The use of Wikipedia® tags has the advantage that large classes of queries (e.g. names of famous actors) that have entertainment intent are reduced to a relatively small number of tags that are commonly included in the top-ranking documents (e.g., in the case of actors, a small number of actor categories in Wikipedia®). Accordingly, the query classification techniques described herein may be capable of generalizing better across search queries than classification techniques that are based on search query text alone, which may be beneficial in scenarios in which the available training data is limited. Using tag ratios that are based on Wikipedia® tags is one example approach for classifying search queries with respect to query intent and is not intended to be limiting.

Finally, consider the task of identifying queries with retail intent, which is defined as product intent classification across the range of all (or a substantial number of) retail products. Query log analysis shows that approximately 5%-7% of distinct Web search queries contain retail intent, though this number varies with date and search engine. Accordingly, retail intent is relatively common at least in the context of Web searches. The tags that are introduced in the context of product intent classification can be used in the context of retail intent classification by using a larger range of product categories. A complementary approach is to use the corpus of advertising bids in the context of sponsored search. In sponsored search, each advertiser uses a set of bid-phrases to indicate for which search queries an ad is potentially shown. The bid-phrases are matched against incoming search queries and are ranked. The top-ranking ads for each search query are shown to users who provided the search query.

It may be presumed that each advertiser is interested in capturing the semantics of queries that may have commercial intent for the subset of products or services that the advertiser is offering. Accordingly, advertisers who have submitted a bid-phrase that corresponds to (e.g., matches) a designated query provide an indication of the retail intent of the designated query. The corpus of bid-phrases may be treated as a set of documents, of which each document is “tagged” with the advertiser who submitted the bid.

The example query classification techniques described herein may use features that are not based on tag ratios in addition to the features that are based on the tag ratios. For instance, such features may be based on a search query including one or more designated words, documents in a search result including one or more designated search terms of the search query, etc.

The corpus of documents that is used for the computation of tag ratios may not include all of the documents that are available for consideration. For example, the corpus of documents may be available on the World Wide Web (WWW). Documents that are available on the World Wide Web are referred to herein as Web documents. In accordance with this example, the corpus of documents that is used for classifying search queries with respect to query intent may not include all of the Web documents that are commonly used by Web search engines. Rather, the corpus may be reduced to include fewer documents (e.g., between one-million to ten-million documents). Reducing the corpus may be beneficial because computing tag ratios for a relatively smaller corpus is less expensive than computing tag ratios for a relatively larger corpus. The example corpus size mentioned above is provided for illustrative purposes and is not intended to be limiting. It will be recognized that the corpus of documents may be any suitable size.

Tags that are used for performing the query classification techniques described herein may be manually created and maintained (such as in Wikipedia®), automatically generated, or received as a part of the corpus. Manually creating and maintaining the tags may provide more control over the documents in the corpus, may help to avoid issues such as spam, and/or may result in more relevant and accurate tags, as compared to the other approaches, though any suitable approach may be used.

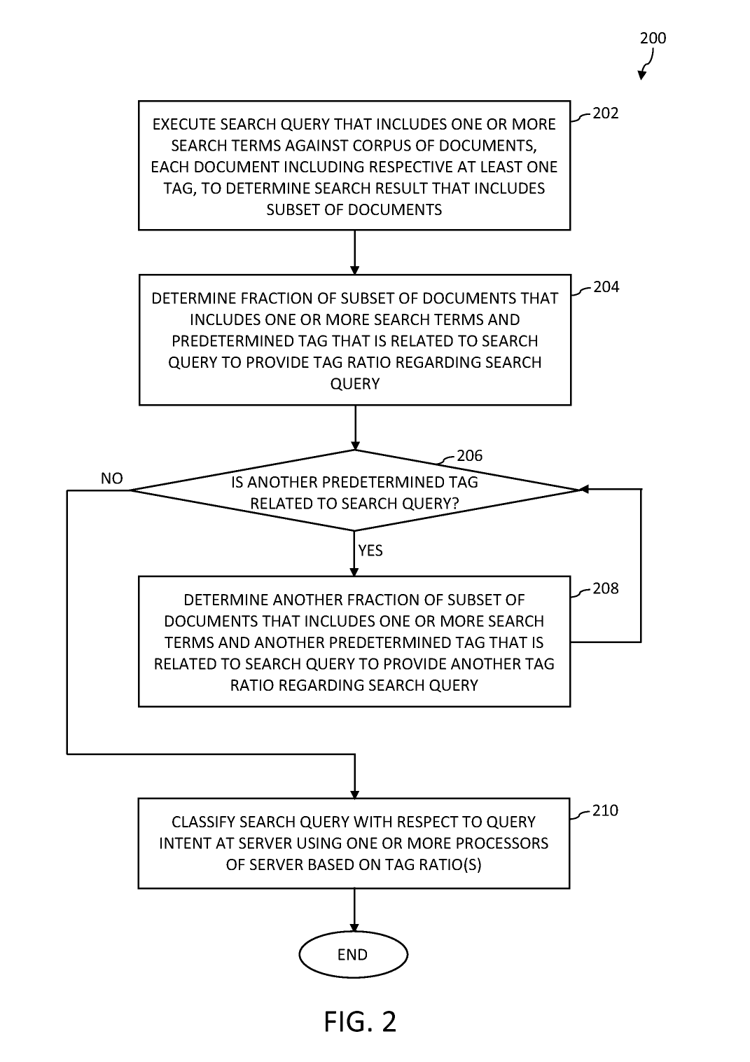

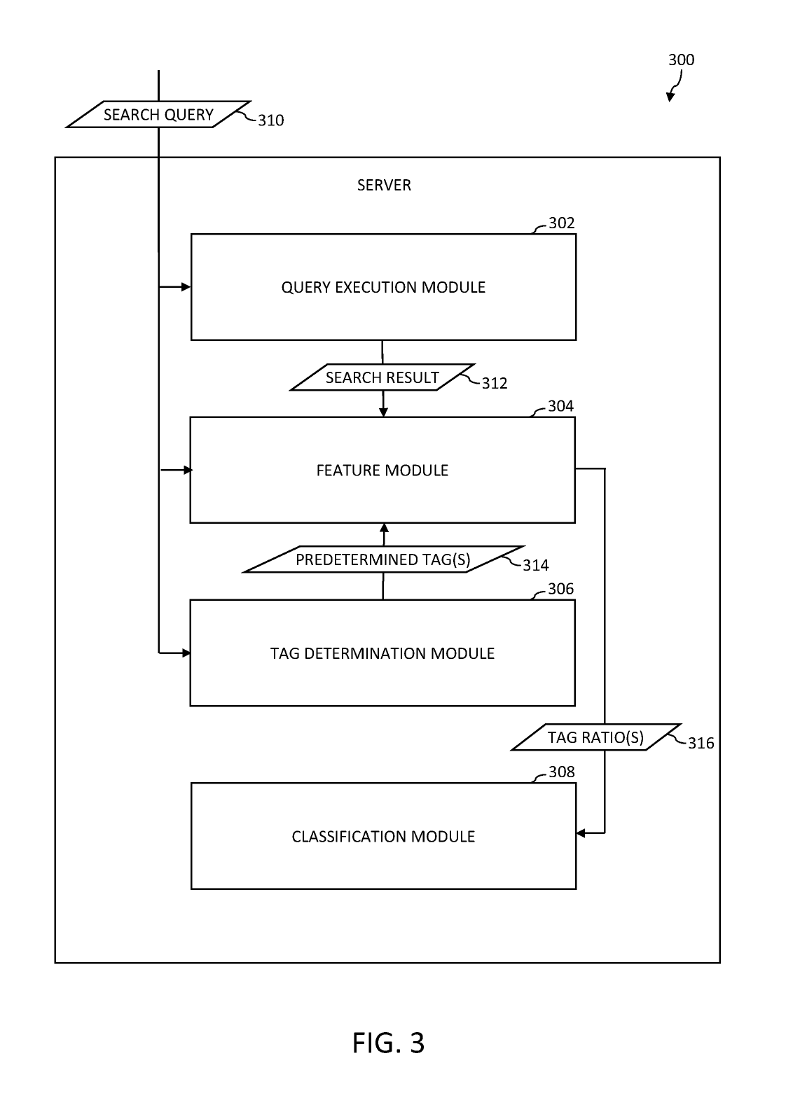

FIG. 2 depicts a flowchart 200 of a method for classifying a search query with respect to query intent using search result tag ratios in accordance with an embodiment. Flowchart 200 is described from the perspective of a server. Flowchart 200 may be performed by any one or more of servers 106A-106N of computer system 100 shown in FIG. 1, for example. For illustrative purposes, flowchart 200 is described with respect to a server 300 shown in FIG. 3, which is an example of a server 106, according to an embodiment. As shown in FIG. 3, server 300 includes a query execution module 302, a feature module 304, a tag determination module 306, and a classification module 308. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, a search query that includes one or more search terms is executed against a corpus of documents to determine a search result that includes a subset of the documents. Each document includes a respective at least one tag. In an example implementation, query execution module 302 executes search query 310 that includes one or more search terms against the corpus of documents to determine search result 312 that includes a subset of the documents.

In accordance with an example embodiment, the search query is a Web search query, and the documents in the corpus are Web documents. Web documents are documents that are available on the World Wide Web. A Web search query is a search query that is executed against a corpus of Web documents.

In accordance with another example embodiment, the documents in the corpus include non-Web documents. Non-Web documents are documents that are not available on the World Wide Web. For instance, all of the documents in the corpus may be non-Web documents.

At step 204, a fraction of the subset of the documents that includes the one or more search terms and a predetermined tag that is related to the search query is determined to provide a tag ratio regarding the search query. For instance, the predetermined tag may indicate a topic of the documents that include the predetermined tag, a type of entity (i.e., subject matter) those documents reference, etc. In an example implementation, feature module 304 determines a fraction of the subset of the documents that includes the one or more search terms of search query 310 and a predetermined tag that is related to search query 310 to provide a tag ratio regarding search query 310. In accordance with this example implementation, tag determination module 306 determines that the predetermined tag is related to search query 310. Tag determination module 306 then provides the predetermined tag as one of predetermined tag(s) 314 to feature module 304 for further processing. Feature module 304 processes the predetermined tag to provide the resulting tag ratio as one of tag ratio(s) 316 to classification module 308.

At step 206, a determination is made whether another predetermined tag is related to the search query. In an example implementation, tag determination module 306 determines whether another predetermined tag is related to search query 310. If another predetermined tag is related to the search query, flow continues to step 208. Otherwise, flow continues to step 210.

At step 208, another fraction of the subset of the documents that includes the one or more search terms and another predetermined tag that is related to the search query is determined to provide another tag ratio regarding the search query. In an example implementation, feature module 304 determines another fraction of the subset of documents that includes the one or more search terms of search query 310 and another predetermined tag that is related to search query 310 to provide another tag ratio regarding search query 310. In accordance with this example implementation, tag determination module 306 determines that another predetermined tag is related to search query 310. Tag determination module 306 provides that predetermined tag as one of predetermined tag(s) 314 to feature module 304 for further processing. Feature module 304 processes that predetermined tag to provide the resulting tag ratio as another one of tag ratio(s) 316 to classification module 308. Upon completion of step 208, flow returns to step 206.

At step 210, the search query is classified with respect to query intent at a server using one or more processors of the server based on the tag ratio(s). In an example implementation, classification module 308 classifies search query 310 based on tag ratio(s) 316. Flowchart 200 ends upon completion of step 210.

In accordance with an example embodiment, the search query is classified using a multiple additive regression tree (MART) technique. A MART technique is a numerical optimization technique that is based on a stochastic gradient boosting paradigm that performs gradient descent optimization in function space, rather than parameter space. MART and other numerical optimization techniques attempt to optimize a fitting function with respect to at least one optimization criterion. One example implementation of a MART technique uses a log-likelihood as the optimization criterion (i.e., loss function), steepest-decent (i.e., gradient descent) as the optimization technique, and binary decision trees as the fitting function.

In some example embodiments, one or more steps 202, 204, 206, 208, and/or 210 of flowchart 200 may not be performed. Moreover, steps in addition to or in lieu of steps 202, 204, 206, 208, and/or 210 may be performed.

It will be recognized that server 300 may not include one or more of query execution module 302, feature module 304, tag determination module 306, and/or classification module 308. Furthermore, server 300 may include modules in addition to or in lieu of query execution module 302, feature module 304, tag determination module 306, and/or classification module 308.

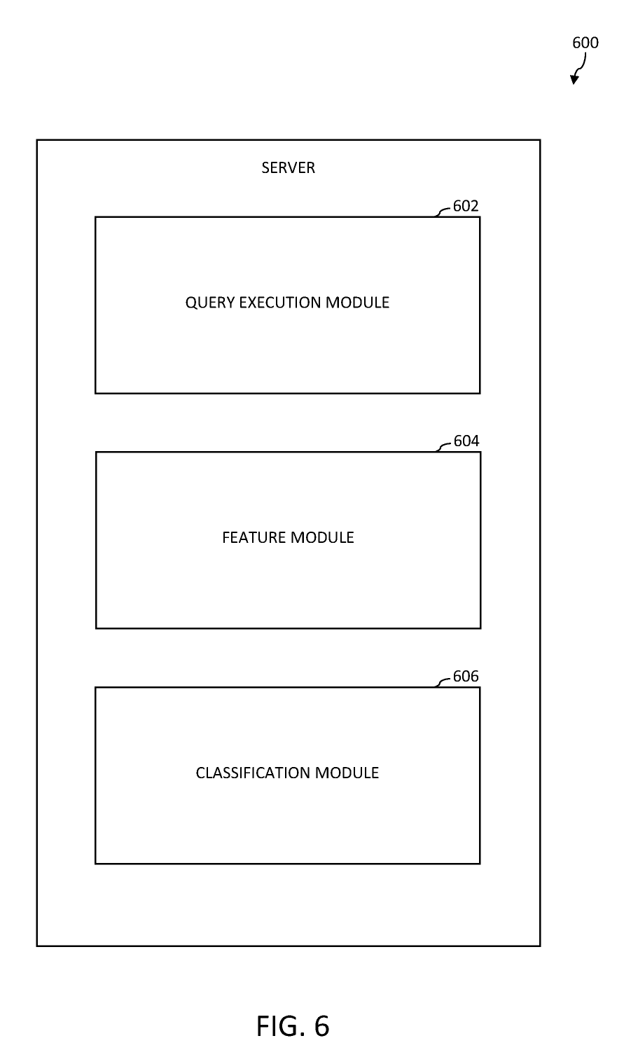

FIGS. 4 and 5 depict flowcharts 400 and 500 that show example ways to implement the method described above with respect to FIG. 2 in accordance with embodiments. For illustrative purposes, flowcharts 400 and 500 are described with respect to a server 600 shown in FIG. 6, which is an example of a server 106, according to an embodiment. As shown in FIG. 6, server 600 includes a query execution module 602, a feature module 604, and a classification module 606. Further structural and operational embodiments will be apparent to persons skilled in the relevant art(s) based on the discussion regarding flowcharts 400 and 500.

As shown in FIG. 4, the method of flowchart 400 begins at step 402. In step 402, a first instance of a search query that includes one or more search terms is executed against a corpus of documents to determine a search result that includes a subset of the documents. Each document includes a respective at least one tag. In an example implementation, query execution module 602 executes the first instance of the search query.

At step 404, a fraction of the subset of the documents that includes the one or more search terms and a predetermined tag that is related to the search query is determined to provide a tag ratio regarding the search query. In an example implementation, feature module 604 determines the fraction of the subset of the documents.

At step 406, a second instance of the search query is executed after execution of the first instance of the search query and after determination of the fraction. In an example implementation, query execution module 602 executes the second instance of the search query.

At step 408, the search query is classified with respect to query intent at a server using one or more processors of the server based on the tag ratio in response to execution of the second instance of the search query. In an example implementation, classification module 606 classifies the search query.

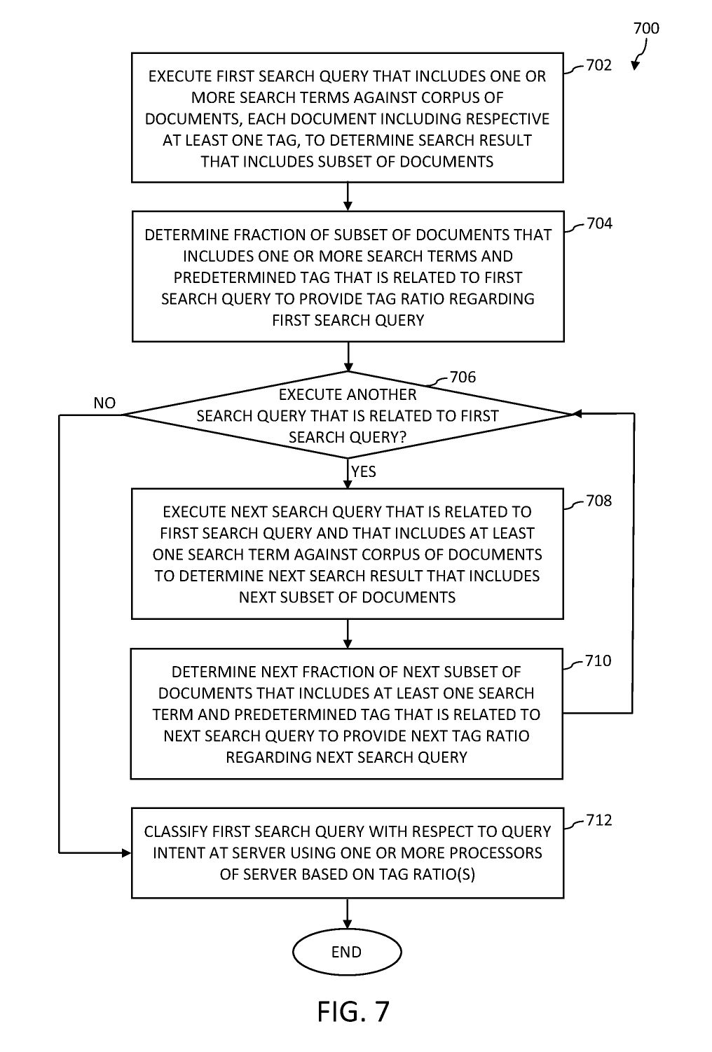

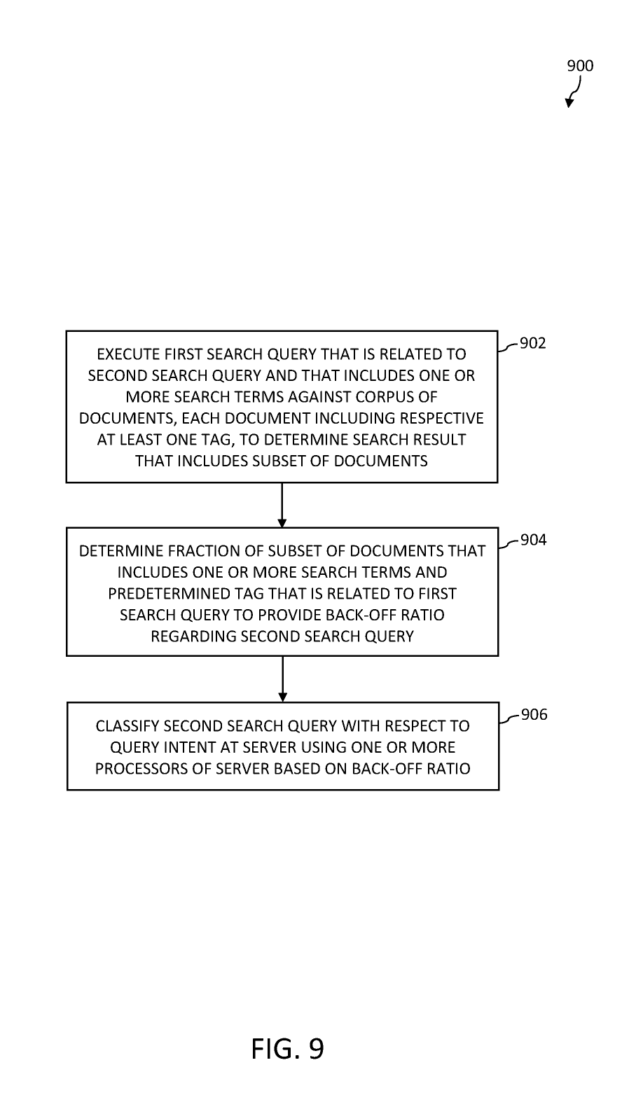

A straight-forward way to use tag ratios for classifying search queries with respect to query intent is to generate a feature vector F for each query q based on the query's tag ratios: F=[ratio(q, t1), . . . , ratio(q, tk)]. However, classification accuracy may be improved by using tag ratios regarding search queries that are related to a search query to be classified in addition to or in lieu of a tag ratio regarding the search query to be classified. FIGS. 5 and 7 depict flowcharts 500 and 700 of example methods in which a tag ratio regarding a first search query q and one or more tag ratios regarding one or more second search queries q′≠q that are related to the first search query are used to classify the first search query with respect to query intent. Example methods in which a tag ratio of a search query to be classified need not necessarily be used in addition to tag ratios of “related” search queries are discussed below with reference to FIGS. 9-14. Some examples of related search queries are provided in the following discussion regarding FIG. 5.

As shown in FIG. 5, the method of flowchart 500 begins at step 502. In step 502, a first search query that includes one or more first search terms is executed against a corpus of documents to determine a first search result that includes a first subset of the documents. Each document includes a respective at least one tag. In an example implementation, query execution module 602 executes the first search query.

At step 504, a fraction of the first subset of the documents that includes the one or more first search terms and a first predetermined tag that is related to the first search query is determined to provide a first tag ratio regarding the first search query. In an example implementation, feature module 604 determines the fraction of the first subset of the documents.

At step 506, a second search query that is related to the first search query and that includes one or more second search terms is executed against the corpus of documents to determine a second search result that includes a second subset of the documents. In an example implementation, query execution module 602 executes the second search query. The second search query may be related to the first search query in any of a variety of ways. For example, one of the search queries may be an acronym of the other. In accordance with this example, the first search query may be “Bavarian Motor Works” and the second search query may be “BMW”. In another example, the first and second search queries may include synonyms. In accordance with this example, the first search query may be “fall leaves” and the second search query may be “autumn foliage”. In yet another example, one of the search queries may be a sub-query of the other. In accordance with this example, the first search query may be “shopping at the Galleria Mall in Houston Tex.” and the second search query may be “Galleria Houston”, which is a sub-query of “shopping at the Galleria Mall in Houston Tex.”.

At step 508, a fraction of the second subset of the documents that includes the one or more second search terms and a second predetermined tag that is related to the second search query is determined to provide a second tag ratio regarding the second search query. The second tag ratio regarding the second search query is referred to as a back-off ratio regarding the first search query. In an example implementation, feature module 604 determines the fraction of the second subset of the documents.

At step 510, the first search query is classified with respect to query intent at a server using one or more processors of the server based on the first tag ratio and the second tag ratio. In an example implementation, classification module 606 classifies the first search query.

As mentioned above, a sub-query is one type of “related” search query. Using tag ratios of a sub-query q′ ⊂ q to classify a search query q with respect to query intent may provide some advantages, as compared to classification techniques that do not use such tag ratios. For example, relatively longer queries may result in small (or even empty) result documents sets, thereby making it difficult to assess the correlation between the individual tags and the words in the query q. Additional estimates of tag incidence may be obtained by considering subsets of the words in the query q, which may result in improved classification accuracy. For instance, the query q={Canon Camera SD2} is likely to surface an empty (or relatively small) result set, because “SD2” is not a valid Canon camera model (though SD5 and SD7 are valid models). However, considering the tag ratios surfaced by the query q′={Canon Camera} may increase the likelihood of an inference that the query q has commercial intent, for example.

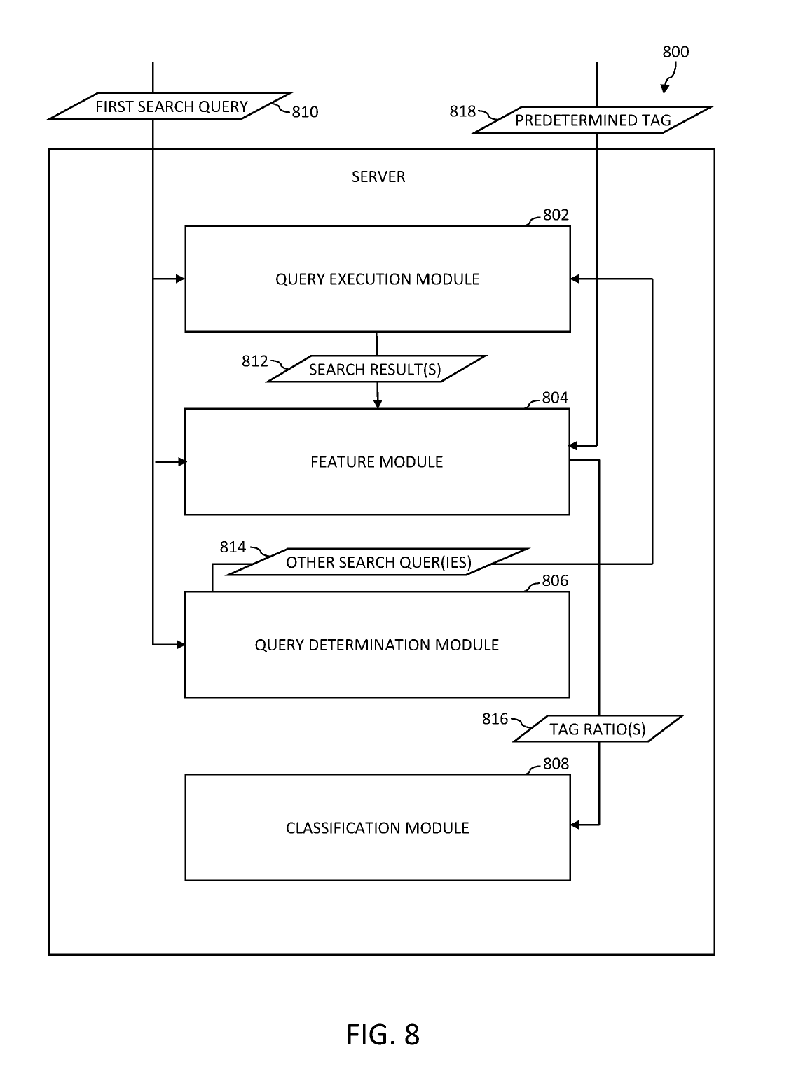

FIG. 7 depicts a flowchart 700 that shows another example way to implement the method described above with respect to FIG. 2 in accordance with an embodiment. For illustrative purposes, flowchart 700 is described with respect to a server 800 shown in FIG. 8, which is an example of a server 106, according to an embodiment. As shown in FIG. 8, server 800 includes a query execution module 802, a feature module 804, a query determination module 806, and a classification module 808. Further structural and operational embodiments will be apparent to persons skilled in the relevant art(s) based on the discussion regarding flowchart 700. Flowchart 700 is described as follows.

As shown in FIG. 7, the method of flowchart 700 begins at step 702. In step 702, a first search query that includes one or more search terms is executed against a corpus of documents to determine a search result that includes a subset of the documents. Each document includes a respective at least one tag. In an example implementation, query execution module 802 executes first search query 810 that includes one or more search terms against the corpus of documents to determine the search result that includes the subset of the documents. In accordance with this example implementation, query execution module 802 provides the search result as one of search result(s) 812 to feature module 804.

At step 704, a fraction of the subset of the documents that includes the one or more search terms and a predetermined tag that is related to the first search query is determined to provide a tag ratio regarding the first search query. In an example implementation, feature module 804 determines a fraction of the subset of the documents that includes the one or more search terms and predetermined tag 818 that is related to first search query 810 to provide a tag ratio regarding first search query 810. In accordance with this example implementation, feature module 804 provides the tag ratio as one of tag ratio(s) 816 to classification module 808.

At step 706, a determination is made whether another search query that is related to the first search query is to be executed. In an example implementation, query determination module 806 determines whether another search query that is related to first search query 810 is to be executed. If another search query that is related to the first search query is to be executed, flow continues to step 708. Otherwise, flow continues to step 712.

At step 708, a next search query that is related to the first search query and that includes at least one search term is executed against the corpus of documents to determine a next search result that includes a next subset of the documents. In an example implementation, query execution module 802 executes a next search query that is related to first search query 810 and that includes at least one search term against the corpus of documents to determine a next search result that includes a next subset of the documents. In accordance with this example implementation, query execution module 802 receives the next search query as one of other search quer(ies) 814 from query determination module 806. Query execution module 802 provides the next search result as one of search result(s) 812 to feature module 804.

At step 710, a next fraction of the next subset of the documents that includes the at least one search term and the predetermined tag that is related to the next search query is determined to provide a next tag ratio regarding the next search query. In an example implementation, feature module 804 determines a next fraction of the next subset of the documents that includes the at least one search term and predetermined tag 818 that is related to the next search query to provide a next tag ratio regarding the next search query. In accordance with this example implementation, feature module 804 provides the next tag ratio as one of tag ratio(s) 816 to classification module 808. Upon completion of step 710, flow continues to step 706.

At step 712, the first search query is classified with respect to query intent at a server using one or more processors of the server based on the tag ratio(s). In an example implementation, classification module 808 classifies first search query 810 based on tag ratio(s) 816.

In some example embodiments, one or more steps 702, 704, 706, 708, 710, and/or 712 of flowchart 700 may not be performed. Moreover, steps in addition to or in lieu of steps 702, 704, 706, 708, 710, and/or 712 may be performed.

It will be recognized that server 800 may not include one or more of query execution module 802, feature module 804, query determination module 806, and/or classification module 808. Furthermore, server 800 may include modules in addition to or in lieu of query execution module 802, feature module 804, query determination module 806, and/or classification module 808.

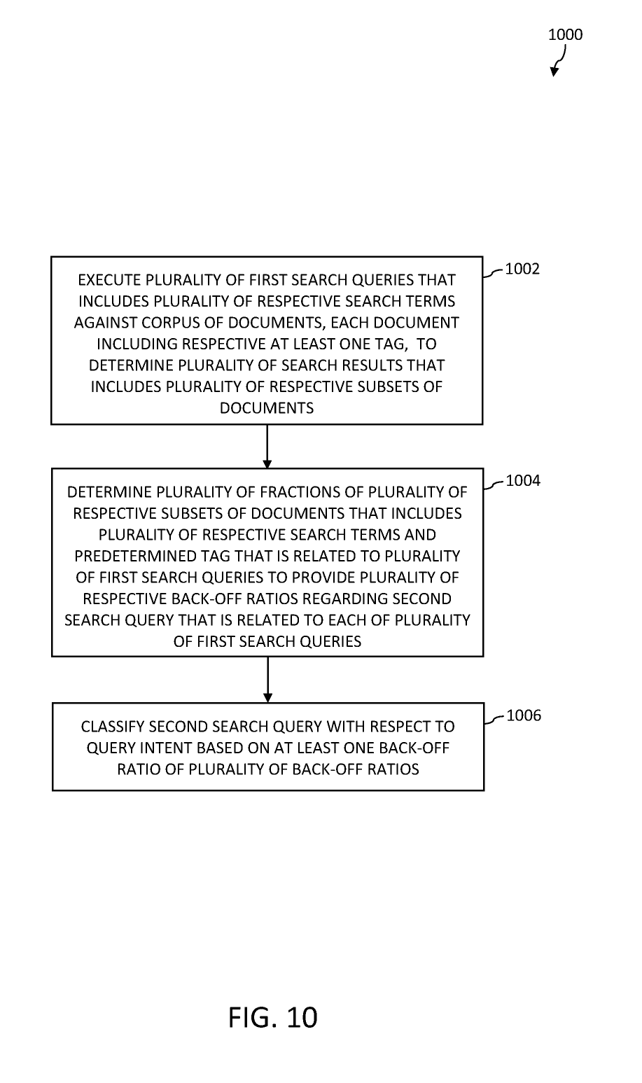

FIG. 9 depicts a flowchart 900 of another method for classifying a search query with respect to query intent using search result tag ratios in accordance with an embodiment. FIG. 10 depicts a flowchart 1000 that shows an example way to implement the method described below with respect to FIG. 9 in accordance with embodiments. Flowcharts 900 and 1000 are described with respect to a server 600 shown in FIG. 6 for illustrative purposes.

As shown in FIG. 9, the method of flowchart 900 begins at step 902. In step 902, a first search query that is related to a second search query and that includes one or more search terms is executed against a corpus of documents to determine a search result that includes a subset of the documents. Each document includes a respective at least one tag. In an example implementation, query execution module 602 executes the first search query.

At step 904, a fraction of the subset of the documents that includes the one or more search terms and a predetermined tag that is related to the first search query is determined to provide a back-off ratio regarding the second search query. In an example implementation, feature module 604 determines the fraction of the subset of the documents.

At step 906, the second search query is classified with respect to query intent at a server using one or more processors of the server based on the back-off ratio. In an example implementation, classification module 606 classifies the second search query.

FIG. 10 depicts a flowchart 1000 that shows an example way to implement the method described above with respect to FIG. 9 in accordance with an embodiment. As shown in FIG. 10, the method of flowchart 1000 begins at step 1002. In step 1002, a plurality of first search queries that includes a plurality of respective search terms is executed against a corpus of documents to determine a plurality of search results that includes a plurality of respective subsets of the documents. Each document includes a respective at least one tag. For instance, the plurality of first search queries may be a plurality of sub-queries of the second search query, though the scope of the embodiments is not limited in this respect. In an example implementation, query execution module 602 executes the plurality of first search queries.

At step 1004, a plurality of fractions of the plurality of respective subsets of the documents that includes the plurality of respective search terms and a predetermined tag that is related to the plurality of first search queries is determined to provide a plurality of respective back-off ratios regarding a second search query that is related to each of the plurality of first search queries. In an example implementation, feature module 604 determines the plurality of fractions of the plurality of respective subsets of the documents.

At step 1006, the second search query is classified with respect to query intent based on at least one back-off ratio of the plurality of back-off ratios. In an example implementation, classification module 606 classifies the second search query.

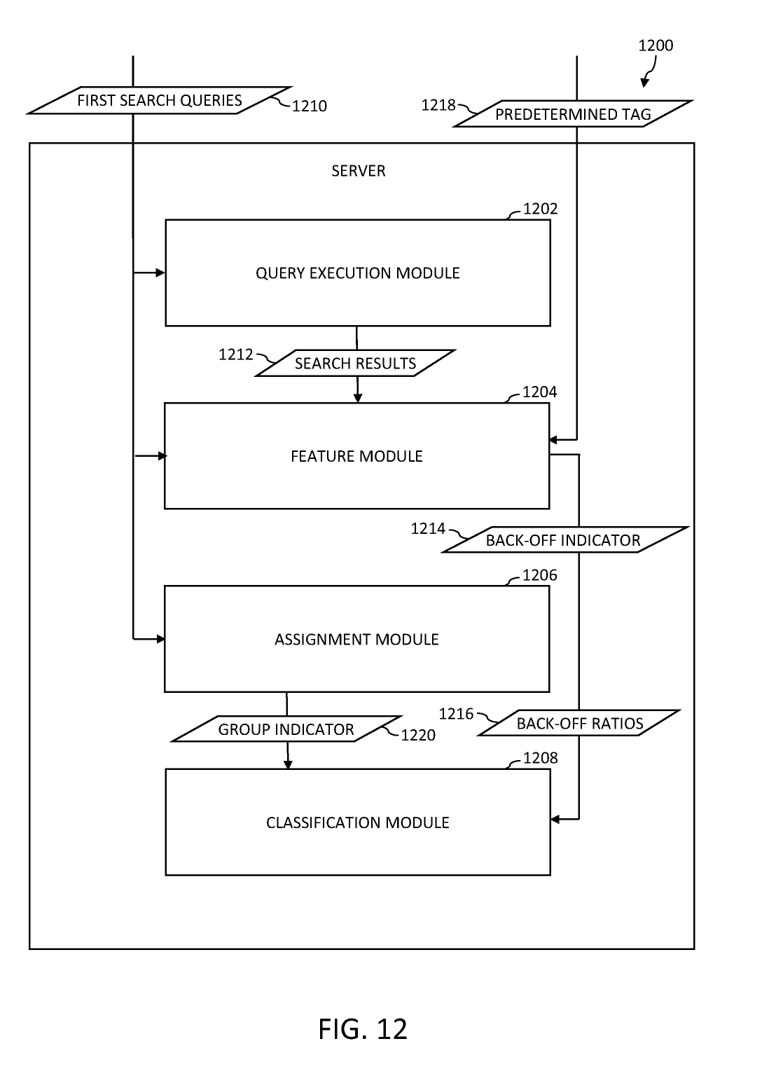

FIG. 11 depicts a flowchart 1100 that shows another example way to implement the method described above with respect to FIG. 9 in accordance with an embodiment. For illustrative purposes, flowchart 1100 is described with respect to a server 1200 shown in FIG. 12, which is an example of a server 106, according to an embodiment. As shown in FIG. 12, server 1200 includes a query execution module 1202, a feature module 1204, an assignment module 1206, and a classification module 1208. Further structural and operational embodiments will be apparent to persons skilled in the relevant art(s) based on the discussion regarding flowchart 1100.

As shown in FIG. 11, the method of flowchart 1100 begins at step 1002. In step 1002, a plurality of first search queries that includes a plurality of respective search terms is executed against a corpus of documents to determine a plurality of search results that includes a plurality of respective subsets of the documents. Each document includes a respective at least one tag. In an example implementation, query execution module 1202 executes a plurality of first search queries 1210 that includes a plurality of respective search terms against a corpus of documents to determine a plurality of search results 1212 that includes a plurality of respective subsets of the documents.

At step 1004, a plurality of fractions of the plurality of respective subsets of the documents that includes the plurality of respective search terms and a predetermined tag that is related to the plurality of first search queries is determined to provide a plurality of respective back-off ratios regarding a second search query that is related to each of the plurality of first search queries. In an example implementation, feature module 1204 determines a plurality of fractions of the plurality of respective subsets of the documents that includes the plurality of respective search terms and predetermined tag 1218 that is related to the plurality of first search queries 1210 to provide a plurality of respective back-off ratios 1216 regarding the second search query.

At step 1102, the plurality of first search queries is assigned among groups based on similarities between the second search query and the first search queries. Each group corresponds to a respective similarity. The similarities between the second search query and the plurality of first search queries may be based on any of a variety of similarity measurement techniques, including but not limited to a purely lexical technique, a stemming technique, a language modeling-based technique, other suitable technique(s), or any combination thereof. In an example implementation, assignment module 1206 assigns the plurality of first search queries 1210 among groups based on similarities between the second search query and the first search queries 1210.

In an example embodiment, instead of assigning the plurality of first search queries among the groups based on similarities between the second search query and the first search queries, the plurality of first search queries are assigned among the groups based on the back-off ratios. In accordance with this example embodiment, instead of each group corresponding to a respective similarity, each group corresponds to a respective value (or range of values) of the back-off ratios.

At step 1104, the second search query is classified with respect to query intent based on back-off ratios that correspond to at least one of the groups. In an example implementation, classification module 1208 classifies the second search query. In accordance with this example implementation, classification module 1208 receives a back-off indicator 1214 from feature module 1204. Back-off indicator 1214 specifies the first search queries 1210 to which the respective back-off ratios 1216 correspond. Classification module 1208 receives a group indicator 1220 from assignment module 1206. Group indicator 1220 specifies the groups to which the first search queries 1210 are assigned. Classification module 1208 cross-references the back-off ratios 1216 with the groups based on back-off indicator 1214 and group indicator 1220, so that classification module 1208 may classify the second search query.

In accordance with an example embodiment, the plurality of first search queries is assigned among the groups based on a plurality of respective numbers of the search terms that the plurality of respective first search queries has in common with the second search query. For example, a group operator π may used for assigning all subsets q′ of the words that are included in the second search query q among the groups. In accordance with this example, the subsets q′ are the first search queries. The group operator may be defined as π(q)={{q′ ∈ 2̂ν|q′⊂ q and |q′∩q|=|s}|s=1, . . . ,|q|}. The variable s represents the number of words in a corresponding group of the subsets q′. The value of the variable s may be limited to a threshold number of words (e.g., 1, 2, 3, etc.), though the scope of the example embodiments is not limited in this respect.

For example, first search queries q′ that share three words with the second search query q may be more likely to result in tag ratios that characterize the query intent of the second search query q than other first search queries q″ that share one word with the second search query q. Accordingly, the second search query q may be classified with respect to query intent based on the back-off ratios that correspond to the group that includes the first search queries q′ that share three words with the second search query. Alternatively, the back-off ratios that correspond to one or more other groups may be used in addition to or in lieu of the back-off ratios that correspond to the group that includes the first search queries q′ that share three words with the second search query.

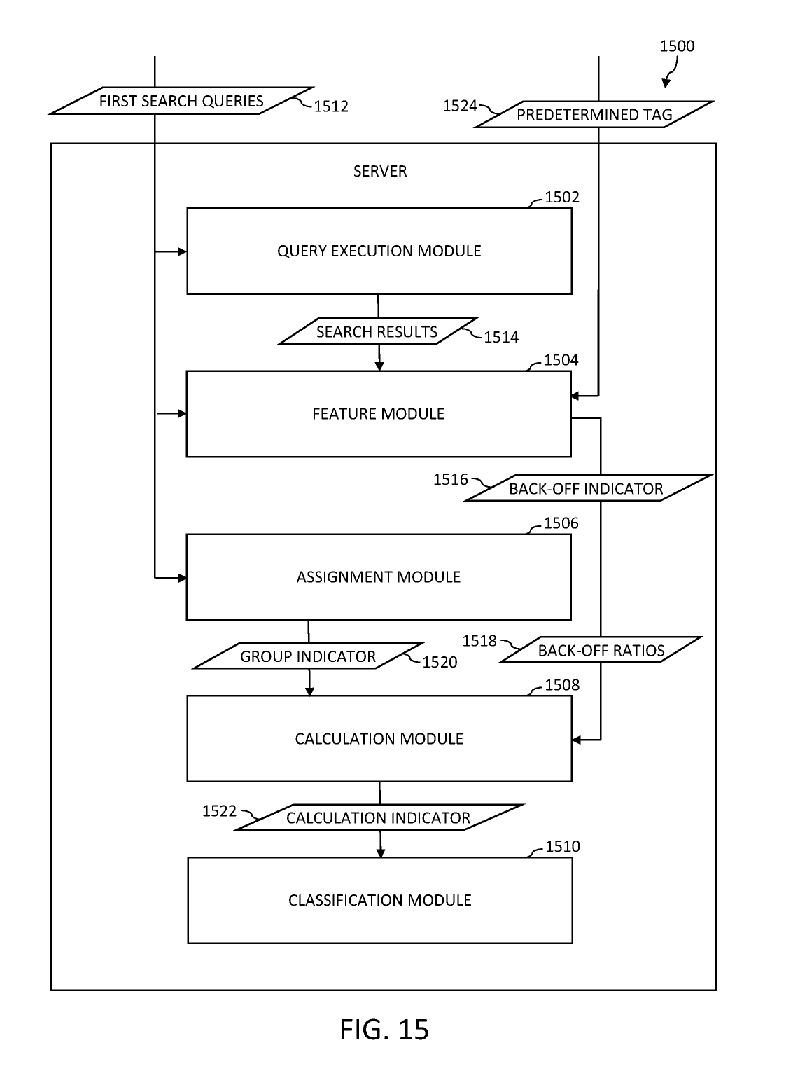

FIGS. 13 and 14 depict flowcharts 1300 and 1400 that show example ways to implement the method described above with respect to FIG. 9 based on a property (e.g., average, sum, standard deviation, minimum, maximum, etc.) of tag ratios in accordance with embodiments. For illustrative purposes, flowcharts 1300 and 1400 are described with respect to a server 1500 shown in FIG. 15, which is an example of a server 106, according to an embodiment. As shown in FIG. 15, server 1500 includes a query execution module 1502, a feature module 1504, an assignment module 1506, a calculation module 1508, and a classification module 1510. Further structural and operational embodiments will be apparent to persons skilled in the relevant art(s) based on the discussion regarding flowcharts 1300 and 1400.

As shown in FIG. 13, the method of flowchart 1300 begins at step 1002. In step 1002, a plurality of first search queries that includes a plurality of respective search terms is executed against a corpus of documents to determine a plurality of search results that includes a plurality of respective subsets of the documents. Each document includes a respective at least one tag. In an example implementation, query execution module 1502 executes a plurality of first search queries 1512 that includes a plurality of respective search terms against a corpus of documents to determine a plurality of search results 1514 that includes a plurality of respective subsets of the documents.

At step 1004, a plurality of fractions of the plurality of respective subsets of the documents that includes the plurality of respective search terms and a predetermined tag that is related to the plurality of first search queries is determined to provide a plurality of respective back-off ratios regarding a second search query that is related to each of the plurality of first search queries. In an example implementation, feature module 1504 determines a plurality of fractions of the plurality of respective subsets of the documents that includes the plurality of respective search terms and predetermined tag 1524 that is related to the plurality of first search queries 1512 to provide a plurality of respective back-off ratios 1518 regarding the second search query.

At step 1102, the plurality of first search queries is assigned among groups based on similarities between the second search query and the first search queries. Each group corresponds to a respective similarity. In an example implementation, assignment module 1506 assigns the plurality of first search queries 1512 among groups based on similarities between the second search query and the first search queries 1512.

At step 1302, at least one average of the back-off ratios that correspond to a respective at least one of the groups is determined. For instance, an average Favg(Qs) of the back-off ratios that correspond to a group Qs may be defined as the summation of all ratio(q′, t) for which q′ ∈ Qs and t ∈ T, divided by the number of queries q′ in the group Qs. In an example implementation, calculation module 1508 determines the at least one average. In accordance with this example implementation, calculation module 1508 receives a back-off indicator 1516 from feature module 1504. Back-off indicator 1516 specifies the first search queries 1512 to which the respective back-off ratios 1518 correspond. Calculation module 1508 receives a group indicator 1520 from assignment module 1506. Group indicator 1520 specifies the groups to which the first search queries 1512 are assigned. Calculation module 1508 cross-references the back-off ratios 1518 with the groups based on back-off indicator 1516 and group indicator 1520, so that calculation module 1508 may determine the at least one average. Calculation module 1508 provides calculation indicator 1522 to classification module 1510. Calculation indicator 1522 specifies the at least one average and the respective at least one of the groups to which the at least one average pertains.

At step 1304, the second search query is classified with respect to query intent based on the at least one average of the back-off ratios that correspond to the respective at least one of the groups. In an example implementation, classification module 1510 classifies the second search query.

In accordance with an example embodiment, at least one sum of the back-off ratios that correspond to the respective at least one of the groups is determined, rather than the at least one average. In accordance with this example embodiment, the second search query is classified with respect to query intent based on the at least one sum, rather than the at least one average.

In accordance with another example embodiment, at least one standard deviation of the back-off ratios that correspond to the respective at least one of the groups is determined, rather than the at least one average. In accordance with this example embodiment, the second search query is classified with respect to query intent based on the at least one standard deviation, rather than the at least one average.

In accordance with yet another embodiment, steps 1302 and 1304 of flowchart 1300 may be replaced with the steps shown in flowchart 1400 of FIG. 14. As shown in FIG. 14, the method of flowchart 1400 begins at step 1402. In step 1402, at least one minimum back-off ratio that corresponds to a respective at least one of the groups is determined. In an example implementation, calculation module 1508 determines the at least one minimum back-off ratio. In accordance with this example implementation, calculation module 1508 receives a back-off indicator 1516 from feature module 1504. Back-off indicator 1516 specifies the first search queries 1512 to which the respective back-off ratios 1518 correspond. Calculation module 1508 receives a group indicator 1520 from assignment module 1506. Group indicator 1520 specifies the groups to which the first search queries 1512 are assigned. Calculation module 1508 cross-references the back-off ratios 1518 with the groups based on back-off indicator 1516 and group indicator 1520, so that calculation module 1508 may determine the at least one minimum back-off ratio. Calculation module 1508 provides calculation indicator 1522 to classification module 1510. Calculation indicator 1522 specifies the at least one minimum back-off ratio and the respective at least one of the groups to which the at least one minimum back-off ratio pertains.

At step 1404, the second search query is classified with respect to query intent based on the at least one minimum back-off ratio that corresponds to the respective at least one of the groups. In an example implementation, classification module 1510 classifies the second search query.

In accordance with an example embodiment, at least one maximum back-off ratio that corresponds to the respective at least one of the groups is determined, rather than the at least one minimum back-off ratio. In accordance with this example embodiment, the second search query is classified with respect to query intent based on the at least one maximum back-off ratio, rather than the at least one minimum back-off ratio.

By way of example, another property that may be used to classify the second search query is the average number of documents in the search results that are provided in response to the first search queries in each group Qs. For example, the average number of documents Count_avg(Qs) may be defined as the summation of all |result(q′)| for which q′ ∈ Qs and t ∈ T, divided by the number of queries q′ in the group Qs. For instance, Count_avg(Qs) may be used to distinguish tag ratios having a value of zero from tag ratios that correspond to empty result sets.

In accordance with another example embodiment, the first search queries are grouped based on a property (e.g., average, sum, standard deviation, minimum, maximum, etc.) of the back-off ratios. For example, once a property of the back-off ratios is determined, as described above with reference to FIGS. 13 and 14, the plurality of first search queries may be re-assigned among updated groups based on the values of the property that correspond to the original groups before the second search query is classified. For instance, a first original group may correspond to a first average back-off ratio value, and a second original group may correspond to a second average back-off ratio that is approximately the same as (or within the same designated range as) the first average back-off ratio. Accordingly, the first search queries that were assigned to the first original group and the first search queries that were assigned to the second original group may be re-assigned to a common updated group. In accordance with this example, instead of classifying the second search query based on a property of the back-off ratios that correspond to the original group(s), the second search query is classified with respect to query intent based on back-off ratios that correspond to at least one of the updated groups.

It should be noted that search engine module 108 of FIG. 1 may include query execution module 302, feature module 304, tag determination module 306, and/or classification module 308 depicted in FIG. 3; query execution module 602, feature module 604, and/or classification module 606 depicted in FIG. 6; query execution module 802, feature module 804, query determination module 806, and/or classification module 808 depicted in FIG. 8; query execution module 1202, feature module 1204, assignment module 1206, and/or classification module 1208 depicted in FIG. 12; query execution module 1502, feature module 1504, assignment module 1506, calculation module 1508, and/or classification module 1510 depicted in FIG. 15; or any portion or combination thereof, for example, though the scope of the example embodiments is not limited in this respect.

Search engine module 108, query execution module 302, feature module 304, tag determination module 306, classification module 308, query execution module 602, feature module 604, classification module 606, query execution module 802, feature module 804, query determination module 806, classification module 808, query execution module 1202, feature module 1204, assignment module 1206, classification module 1208, query execution module 1502, feature module 1504, assignment module 1506, calculation module 1508, and classification module 1510 may be implemented in hardware, software, firmware, or any combination thereof.

For example, search engine module 108, query execution module 302, feature module 304, tag determination module 306, classification module 308, query execution module 602, feature module 604, classification module 606, query execution module 802, feature module 804, query determination module 806, classification module 808, query execution module 1202, feature module 1204, assignment module 1206, classification module 1208, query execution module 1502, feature module 1504, assignment module 1506, calculation module 1508, and/or classification module 1510 may be implemented as computer program code configured to be executed in one or more processors.

In another example, search engine module 108, query execution module 302, feature module 304, tag determination module 306, classification module 308, query execution module 602, feature module 604, classification module 606, query execution module 802, feature module 804, query determination module 806, classification module 808, query execution module 1202, feature module 1204, assignment module 1206, classification module 1208, query execution module 1502, feature module 1504, assignment module 1506, calculation module 1508, and/or classification module 1510 may be implemented as hardware logic/electrical circuitry.

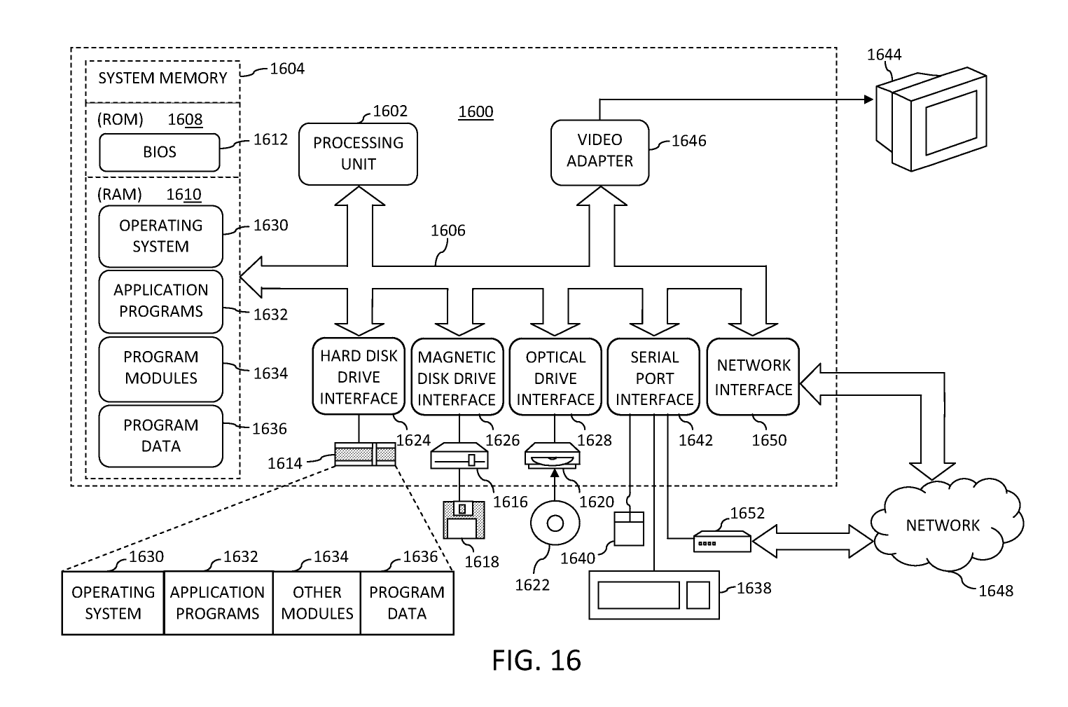

FIG. 16 depicts an example computer 1600 in which embodiments may be implemented. Any one or more of the user systems 102A-102M or the servers 106A-106N shown in FIG. 1 (or any one or more subcomponents thereof shown in FIGS. 3, 6, 8, 12, and 15) may be implemented using computer 1600, including one or more features of computer 1600 and/or alternative features. Computer 1600 may be a general-purpose computing device in the form of a conventional personal computer, a mobile computer, or a workstation, for example, or computer 1600 may be a special purpose computing device. The description of computer 1600 provided herein is provided for purposes of illustration, and is not intended to be limiting. Embodiments may be implemented in further types of computer systems, as would be known to persons skilled in the relevant art(s).

As shown in FIG. 16, computer 1600 includes a processing unit 1602, a system memory 1604, and a bus 1606 that couples various system components including system memory 1604 to processing unit 1602. Bus 1606 represents one or more of any of several types of bus structures, including a memory bus or memory controller, a peripheral bus, an accelerated graphics port, and a processor or local bus using any of a variety of bus architectures. System memory 1604 includes read only memory (ROM) 1608 and random access memory (RAM) 1610. A basic input/output system 1612 (BIOS) is stored in ROM 1608.

Computer 1600 also has one or more of the following drives: a hard disk drive 1614 for reading from and writing to a hard disk, a magnetic disk drive 1616 for reading from or writing to a removable magnetic disk 1618, and an optical disk drive 1620 for reading from or writing to a removable optical disk 1622 such as a CD ROM, DVD ROM, or other optical media. Hard disk drive 1614, magnetic disk drive 1616, and optical disk drive 1620 are connected to bus 1606 by a hard disk drive interface 1624, a magnetic disk drive interface 1626, and an optical drive interface 1628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1630, one or more application programs 1632, other program modules 1634, and program data 1636. Application programs 1632 or program modules 1634 may include, for example, computer program logic for implementing search engine module 108, query execution module 302, feature module 304, tag determination module 306, classification module 308, query execution module 602, feature module 604, classification module 606, query execution module 802, feature module 804, query determination module 806, classification module 808, query execution module 1202, feature module 1204, assignment module 1206, classification module 1208, query execution module 1502, feature module 1504, assignment module 1506, calculation module 1508, classification module 1510, flowchart 200 (including any step of flowchart 200), flowchart 400 (including any step of flowchart 400), flowchart 500 (including any step of flowchart 500), flowchart 700 (including any step of flowchart 700), flowchart 900 (including any step of flowchart 900), flowchart 1000 (including any step of flowchart 1000), flowchart 1100 (including any step of flowchart 1100), flowchart 1300 (including any step of flowchart 1300), and/or flowchart 1400 (including any step of flowchart 1400), as described herein.

A user may enter commands and information into the computer 1600 through input devices such as keyboard 1638 and pointing device 1640. Other input devices (not shown) may include a microphone, joystick, game pad, satellite dish, scanner, or the like. These and other input devices are often connected to the processing unit 1602 through a serial port interface 1642 that is coupled to bus 1606, but may be connected by other interfaces, such as a parallel port, game port, or a universal serial bus (USB).

A display device 1644 (e.g., a monitor) is also connected to bus 1606 via an interface, such as a video adapter 1646. In addition to display device 1644, computer 1600 may include other peripheral output devices (not shown) such as speakers and printers.

Computer 1600 is connected to a network 1648 (e.g., the Internet) through a network interface or adapter 1650, a modem 1652, or other means for establishing communications over the network. Modem 1652, which may be internal or external, is connected to bus 1606 via serial port interface 1642.

As used herein, the terms “computer program medium” and “computer-readable medium” are used to generally refer to media such as the hard disk associated with hard disk drive 1614, removable magnetic disk 1618, removable optical disk 1622, as well as other media such as flash memory cards, digital video disks, random access memories (RAMs), read only memories (ROM), and the like.

As noted above, computer programs and modules (including application programs 1632 and other program modules 1634) may be stored on the hard disk, magnetic disk, optical disk, ROM, or RAM. Such computer programs may also be received via network interface 1650 or serial port interface 1642. Such computer programs, when executed or loaded by an application, enable computer 1600 to implement features of embodiments discussed herein. Accordingly, such computer programs represent controllers of the computer 1600.

Example embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described example embodiments, but should be defined only in accordance with the following claims and their equivalents.

What is claimed is:

1. A method comprising:
executing a first instance of a first search query that includes one or more first search terms against a corpus of documents, each document including a respective at least one tag, to determine a search result that includes a subset of the documents;
determining a fraction of the subset of the documents that includes the one or more first search terms and a predetermined tag that is related to the first search query to provide a tag ratio regarding the first search query; and
classifying the first search query with respect to query intent at a server using one or more processors of the server based on the tag ratio.

2. The method of claim 1, further comprising:
determining a second fraction of the subset of the documents that includes the one or more first search terms and a second predetermined tag that is related to the first search query to provide a second tag ratio regarding the first search query;
wherein the classifying the first search query is further based on the second tag ratio.

3. The method of claim 1, wherein the predetermined tag indicates a topic to which the fraction of the subset of the documents pertains.

4. The method of claim 1, further comprising:
executing a second instance of the first search query;
wherein the executing the first instance of the first search query and the determining the fraction are performed before the executing the second instance of the first search query; and
wherein the classifying the first search query is performed in response to the executing the second instance of the first search query.

5. The method of claim 1, further comprising:
executing a second search query that is related to the first search query and that includes one or more second search terms against the corpus of documents to determine a second search result that includes a second subset of the documents; and
determining a fraction of the second subset of the documents that includes the one or more second search terms and a second predetermined tag that is related to the second search query to provide a second tag ratio regarding the second search query;
wherein the classifying the first search query is further based on the second tag ratio.

6. The method of claim 5, wherein the second search query is a sub-query of the first search query.

7. The method of claim 1, wherein the first search query is a Web search query; and
wherein the documents are Web documents.

8. The method of claim 1, wherein the documents are non-Web documents.

9. The method of claim 1, wherein the classifying the first search query is performed using a multiple additive regression tree technique.

10. A method comprising:
executing a first search query that is related to a second search query and that includes one or more search terms against a corpus of documents, each document including a respective at least one tag, to determine a search result that includes a subset of the documents;
determining a fraction of the subset of the documents that includes the one or more search terms and a predetermined tag that is related to the first search query to provide a first back-off ratio regarding the second search query; and
classifying the second search query with respect to query intent at a server using one or more processors of the server based on the first back-off ratio.

11. The method of claim 10, wherein the executing the first search query comprises:
executing a plurality of first search queries that includes a plurality of respective search terms against the corpus of the documents to determine a plurality of search results that includes a plurality of respective subsets of the documents;
wherein the determining the fraction of the subset comprises:
determining a plurality of fractions of the plurality of respective subsets of the documents that includes the plurality of respective search terms and the predetermined tag that is related to the plurality of first search queries to provide a plurality of respective back-off ratios regarding a second search query that is related to each of the plurality of first search queries; and
wherein the classifying the second search query comprises:
classifying the second search query with respect to query intent based on at least the first back-off ratio of the plurality of back-off ratios.

12. The method of claim 11, wherein the second search query includes a plurality of words; and
wherein the plurality of first search queries is a plurality of respective sub-queries of the second search query, each sub-query including a respective subset of the plurality of words.

13. The method of claim 11, further comprising:
assigning the plurality of first search queries among groups based on similarities between the second search query and the first search queries, each group corresponding to a respective similarity;
wherein the classifying the second search query comprises:
classifying the second search query with respect to query intent based on the back-off ratios that correspond to at least one of the groups.

14. The method of claim 13, wherein the assigning the plurality of first search queries comprises:
assigning the plurality of first search queries among the groups based on a plurality of respective numbers of the search terms that the plurality of respective first search queries has in common with the second search query.

15. The method of claim 13, further comprising:
determining at least one average of the back-off ratios that correspond to the respective at least one of the groups;
wherein the classifying the second search query comprises:
classifying the second search query with respect to query intent based on the at least one average of the back-off ratios that correspond to the respective at least one of the groups.

16. The method of claim 13, further comprising:
determining at least one sum of the back-off ratios that correspond to the respective at least one of the groups;
wherein the classifying the second search query comprises:
classifying the second search query with respect to query intent based on the at least one sum of the back-off ratios that correspond to the respective at least one of the groups.

17. The method of claim 13, further comprising:
determining at least one standard deviation of the back-off ratios that correspond to the respective at least one of the groups;
wherein the classifying the second search query comprises:
classifying the second search query with respect to query intent based on the at least one standard deviation of the back-off ratios that correspond to the respective at least one of the groups.

18. The method of claim 13, further comprising:
determining at least one minimum back-off ratio that corresponds to the respective at least one of the groups;
wherein the classifying the second search query comprises:
classifying the second search query with respect to query intent based on the at least one minimum back-off ratio that corresponds to the respective at least one of the groups.

19. The method of claim 13, further comprising:
determining at least one maximum back-off ratio that corresponds to the respective at least one of the groups;
wherein the classifying the second search query comprises:
classifying the second search query with respect to query intent based on the at least one maximum back-off ratio that corresponds to the respective at least one of the groups.

20. A system comprising:
a query execution module configured to execute a Web search query that includes a plurality of search terms against a corpus of documents, each document including a respective at least one tag, to determine a first Web search result that includes a first subset of the documents, the query execution module further configured to execute a sub-query of the Web search query that includes at least one search term of the plurality of search terms against the corpus of documents to determine a second Web search result that includes a second subset of the documents;
a fraction determination module configured to determine a first fraction of the first subset of the documents that includes the plurality of search terms and a predetermined tag that is related to the Web search query to provide a tag ratio regarding the Web search query, the fraction determination module further configured to determine a second fraction of the second subset of the documents that includes the at least one search term and the predetermined tag that is further related to the sub-query to provide a back-off ratio regarding the Web search query; and
a classification module configured to classify the Web search query with respect to query intent based on the tag ratio and the back-off ratio.
